(19) United States
(12) Patent Application Publication
(10) Pub. No.: US 2015/0178696 A1
(43) Pub. Date: Jun. 25, 2015

(54) SYSTEM AND METHOD FOR PERFORMING CALLBACKS IN AN AUTOMATED CLEARING HOUSE NETWORK

(71) Applicant: Cube, Co., Mountain View, CA (US)

(72) Inventor: Joel Christner, Mountain View, CA (US)

(73) Assignee: Cube, Co., Mountain View, CA (US)

(21) Appl. No.: 14/139,100

(22) Filed: Dec. 23, 2013

(51) Int. Cl. G06Q 20/10; G06Q 20/02

(52) U.S. Cl. CPC G06Q 20/10; G06Q 20/023; G06Q 40/02

(57) ABSTRACT

A system and method is provided for performing callbacks in a commercial transaction processing system. The system includes a transaction processor to receive a transaction request from a user. The transaction request includes an amount to be transferred between a user account and a first bank account associated with a first bank. A second bank is coupled to the transaction processor to transmit an instruction to the first bank to transfer the amount between the first bank account and the user account. The second bank receives a response from the first bank indicating whether the amount can be transferred, and selectively generates a callback message based on the response from the first bank. The transaction processor further determines whether to update the user account to reflect the amount to be transferred based, at least in part, on the callback message.

### TECHNICAL FIELD

Examples described herein relate to commercial transactions, and more specifically, to performing callbacks in an Automated Clearing House network.

### BACKGROUND

Automated Clearing House (ACH) is a banking network that facilitates electronic transfer of funds (i.e., through debit and/or credit transactions) between financial institutions. ACH transactions are typically processed on a scheduled basis, in “batches,” wherein a large volume of debit and/or credit transactions are typically processed at a time. For example, a merchant may use ACH to process payroll (i.e., direct deposit). Specifically, the merchant may instruct its bank to transfer funds from a merchant bank account to each employee's personal bank account. The merchant's bank may perform a cursory review of the employee bank information, for example, to ensure that the routing numbers are valid. The bank then sends an instruction to the ACH network requesting that the appropriate amount be credited to each of the employees' bank accounts. Upon receiving the ACH instruction, each of the employees' banks sends a response to the ACH network, which is propagated to the merchant's bank, either confirming that the amount was credited or indicating that the amount could not be credited (e.g., including the reasons why).

Furthermore, the merchant may also wish to retrieve funds from customer bank accounts. For example, the merchant may instruct its bank to transfer funds from each customer's bank account to the merchant bank account. Again, the merchant bank may perform a cursory review of the customer bank routing number, and, assuming the customer bank routing number is valid, send an instruction to the ACH network requesting that the appropriate amount be debited from each of the customers' bank accounts. Upon receiving the ACH instruction, each of the customers' banks sends a response to the ACH network, which is propagated to the merchant's bank, either confirming the amount was debited or indicating that the amount could not be debited (and the reasons why).

An ACH transaction may be unsuccessful for a number of reasons. For example, the target (e.g., employee's or customer's) bank account may have insufficient funds to complete the transaction, the account owner may have told the bank to stop payment, and/or the account number may be invalid (e.g., the account was closed or never existed in the first place) even though the routing number is legitimate. When a credit transaction fails, the funds are simply returned to the merchant's bank account. However, when a debit transaction fails, the funds should not be made available to the merchant since they were never successfully retrieved from the customer's bank account. For this reason, the merchant's bank should not update the merchant's bank account ledger to reflect the availability of funds until receiving a response from the ACH network indicating that the transaction was successfully funded by the customer's bank.

Although ACH transactions can be properly accounted for between banks or other financial institutions that have direct access to the ACH network, they may pose a serious problem for third-party services (e.g., transaction processors) that operate as an intermediary between the merchant and one or more banks in the ACH network. Third-party services are typically blind to the ACH transactions which take place between banks in an ACH network. As a result, a third-party service is typically notified of a failed transaction by a corresponding bank that performs ACH transactions on the service's behalf. However, such notifications are received (if at all) in the form of an email or snail mail sent to a human operator of the third-party service. The operator is responsible for manually correcting any accounting errors that may have occurred as a result of the failed transaction. This process is highly inefficient and, as a result, many accounting errors may become uncorrectable by the time an operator is actually aware of any failed transactions. Further, many fraud scenarios are possible because of the inability to automate the processing and handling of failed ACH instructions.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

A system and method is provided for performing callbacks in a commercial transaction processing system. The system includes a transaction processor to receive a transaction request from a user. The transaction request includes an amount to be transferred between a user account and a first bank account associated with a first bank. A second bank is coupled to the transaction processor to transmit an instruction to the first bank to transfer the amount between the first bank account and the user account. The second bank receives a response from the first bank (directly, or through a transaction network such as ACH) indicating whether the amount can be transferred, and selectively generates a callback message based on the response from the first bank. The transaction processor further determines whether to update the user account to reflect the amount to be transferred based, at least in part, on the callback message. For some embodiments, the second bank communicates with the first bank via an Automated Clearing House (ACH) network.

For some embodiments, the callback message may indicate whether the amount was successfully debited from or credited to the first bank account. For example, if the amount to be transferred includes an amount to be credited to the first bank account, the transaction processor may debit the amount from the user account if the callback message indicates that the amount was successfully credited to the first bank account. If the amount to be transferred includes an amount to be debited from the first bank account, the transaction processor may credit the amount to the user account if the callback message indicates that the amount was successfully debited from the first bank account. For some embodiments, the second bank may deposit the amount in a second bank account upon receiving the amount from the first bank.

For some embodiments, the second bank may generate the callback message regardless of whether or not the amount was successfully debited from or credited to the first bank account. For other embodiments, the second bank may generate the callback message only if the response from the first bank indicates that the amount was not debited from or credited to the first bank account. For example, the callback message may indicate that the transaction request could not be completed. Accordingly, the transaction processor may update the user account if no callback message is received after a predetermined amount of time has elapsed. For some embodiments, the callback message may indicate that the transaction request could not be completed because: the first bank account does not exist; the first bank account has insufficient funds; a stop payment request was issued for the first bank account; and/or the first bank account is closed or no longer active.

Performing callbacks to the transaction processor based on inter-bank (e.g., ACH) communications allows the transaction processor to programmatically account for and/or respond to any failed transactions. Because they may be implemented in software, callback messages provide a reliable means of indicating (to the transaction processor) whether or not a transaction between banks was successful. For example, the transaction processor may hold off on updating the user account for a period of time within which it would expect to receive a callback message (if any) from a corresponding bank. This may significantly reduce and/or eliminate accounting errors by the transaction processor, while also reducing overhead costs (e.g., human resources).

### BRIEF DESCRIPTION OF THE DRAWINGS

The present embodiments are illustrated by way of example and are not intended to be limited by the figures of the accompanying drawings where:

FIG. 1 illustrates a system for processing commercial transactions, in accordance with some embodiments;

FIG. 2 is an illustrative flow chart depicting a commercial transaction processing operation, in accordance with some embodiments;

FIG. 3 is an illustrative flow chart depicting a callback operation for processing debit requests, in accordance with some embodiments;

FIG. 4 is an illustrative flow chart depicting a callback operation for processing credit requests, in accordance with some embodiments; and

FIG. 5 is a block diagram that illustrates a computer system upon which embodiments described herein may be implemented.

### DETAILED DESCRIPTION

In the following description, numerous specific details are set forth such as examples of specific components, circuits, and/or processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

Examples described herein provide a system and method for performing callbacks in a commercial transaction processing system. According to some embodiments, the system includes a transaction processor and a source bank that is coupled to and/or associated with the transaction processor. The transaction processor may receive a transaction request specifying an amount to be transferred between a user account and a target bank account associated with a target bank. The source bank may transmit an instruction to the target bank (e.g., via an Automated Clearing House network) to transfer the amount between the target bank account and a source bank account associated with the source bank. The source bank then receives a response from the target bank indicating whether the amount can be transferred, and selectively generates a callback message based on the response from the target bank. Finally, the transaction processor determines whether to update the user account to reflect the amount to be transferred based, at least in part, on the callback message.

Among other benefits, examples described herein recognize that third-party transaction processors lack adequate knowledge regarding the status of inter-bank transactions, which often leads to accounting errors by such third-party services. For example, a customer or user of a third-party service may initiate a debit request specifying an unauthorized or nonexistent bank account (associated with a target bank) to be debited. The transaction processor may subsequently send an instruction to a source bank to retrieve the amount to be debited from the target bank. The source bank may first determine whether the routing number for the target bank indicates a valid bank. It should be noted, however, that the source bank typically has no advance knowledge about the individual bank accounts associated with the target bank. Thus, assuming the routing number is valid, the source bank notifies the transaction processor that the transaction is authorized. Under conventional implementations, the transaction processor would credit the amount to the user's account upon receiving such authorization from the source bank, even before the source bank has attempted (and failed) to retrieve the amount from the target bank.

Examples herein further recognize that the operators of third-party services often suffer significant monetary loss as a result of inadequate notification regarding failed inter-bank transactions. For example, under conventional implementations, a source bank notifies a corresponding transaction processor of a failed transaction (if at all) in the form of an email or snail mail notification sent to a human operator or administrator of transaction processor. However, a user may have already transferred out the funds credited to his/her account, and absconded with the money (e.g., by closing the bank account to which the funds were transferred to), before the administrator realizes and/or has a chance to correct the accounting error. Therefore, examples herein provide a mechanism for the source bank to “call back” and/or programmatically notify the transaction processor of a failed transaction attempt. Accordingly, the transaction processor may avoid accounting errors by refraining from crediting a user's account until it receives a callback message from the source bank indicating the transaction was successful (or if no callback message is received after a predetermined amount of time has elapsed).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

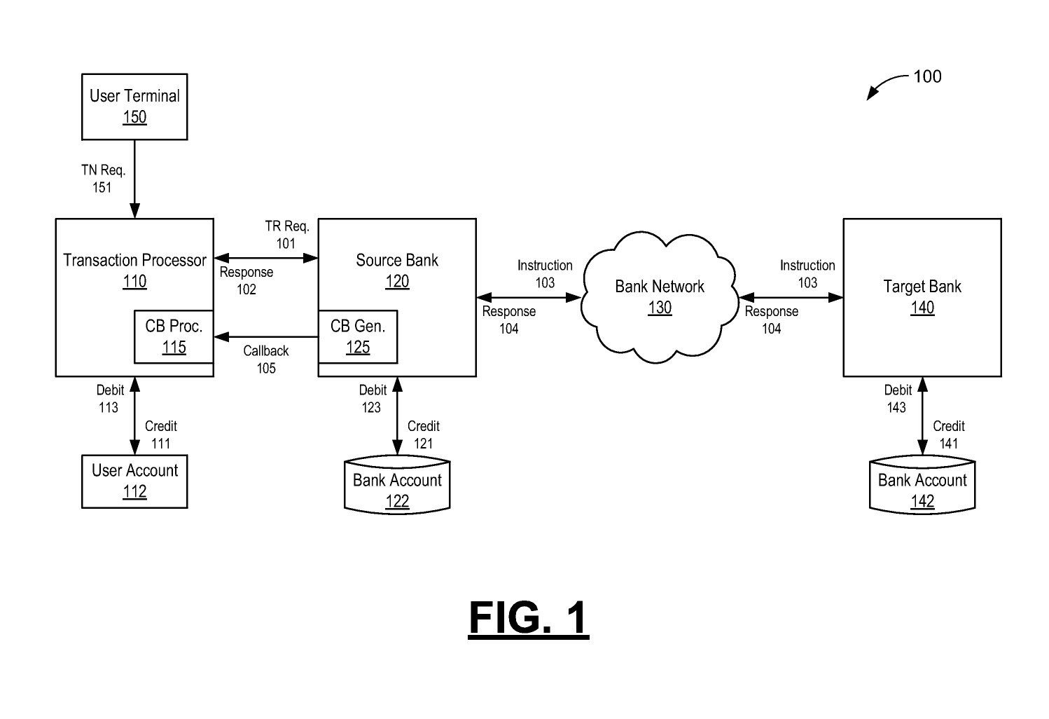

FIG. 1 illustrates a system for processing commercial transactions, in accordance with some embodiments. The system includes a transaction processor 110, a source bank 120, a bank network 130, a target bank 140, and a user terminal 150. The user terminal 150 may correspond to a desktop computer, laptop, tablet, smartphone, PDA, and/or any other personal computing device capable of communicating with the transaction processor 110 (e.g., via the Internet). The transaction processor 110 facilitates commercial/financial transactions between one or more users of the transaction processor 110 and third parties. Specifically, the transaction processor 110 maintains a user account 112 for each of its users. For some embodiments, the user account 112 may correspond to a ledger indicating an amount that a particular user has on deposit with the transaction processor 110. The transaction processor 110 is further coupled to the source bank 120 and has a bank account 122 associated therewith. For some embodiments, the bank account 122 stores the funds associated with each user account 112 maintained by the transaction processor 110.

The transaction processor 110 receives a transaction (TN) request 151, from the user terminal 150, specifying an amount to be transferred between the user account 112 and a bank account 142 (i.e., the “target” bank account) associated with a target bank 140. The transaction processor 110 then sends a transfer (TR) request 101 to the source bank 120 indicating an amount to be retrieved from the target bank account 142. The TR request 101 may include information identifying the target bank account 142 (e.g., an account number) as well as the target bank 140 (e.g., a routing number). For some embodiments, the source bank 120 analyzes the TR request 101 to determine whether the routing number is associated with a valid bank. The source bank 120 may further send a response 102 to the transaction processor 110 indicating whether the transaction is authorized (e.g., whether the routing number is valid).

Assuming the requested transaction is authorized, the source bank 120 may then transmit an instruction 103 to the target bank 140, via the bank network 130, to initiate a transfer of funds between the target bank account 142 and the bank account 122 (i.e., the “source” bank account). For example, the instruction 103 may include the information identifying the target bank 140 and the target bank account 142, as well as the amount to be transacted with the target bank account 142. The bank network 130 facilitates electronic communications between the source bank 120 and the target bank 140. More specifically, the bank network 130 enables the source bank 120 to initiate debit and/or credit transactions with the target bank 140. For some embodiments, the bank network 130 may correspond to an Automated Clearing House (ACH) network (e.g., operated by the National Automated Clearing House Association). For example, the source bank 120 may upload a large batch of instructions 103 to the bank network 130 on a regular and/or scheduled basis. The bank network 130 routes each instruction 103 to the appropriate target bank 140.

The target bank 140 analyzes the instruction 103 to determine whether the requested transaction can be completed. For example, the target bank 140 may determine whether the account information included with the instruction 103 identifies a valid (and active) bank account. If the instruction 103 corresponds to a debit request, the target bank 140 may also determine whether the target bank account 142 is sufficiently funded given the transaction amount specified by the instruction 103. Assuming the target bank account 142 is valid (and sufficiently funded), the target bank 140 may credit 141 the amount to, or debit 143 the amount from, the target bank account 142. The target bank 140 then transmits a response 104 back to the source bank 120 indicating whether or not the transaction was completed. For example, the response 104 may indicate that the target bank account 142 was successfully credited or debited for the requested amount. For some embodiments, the response 104 may include one or more reasons why a particular transaction could not be completed. For example, the response 104 may indicate that: the target bank account 142 does not exist; the target bank account 142 has insufficient funds; a stop payment request was issued for the target bank account 142; and/or the target bank account 142 is closed or no longer active.

The response 104 is routed, via the bank network 130, back to the source bank 120. The source bank 120 then makes the appropriate changes to the source bank account 122 based on the response 104. For example, if the response 104 indicates that a credit transaction was successful (i.e., the target bank account 142 was successfully credited 141 for the transaction amount), the source bank 120 debits 123 the source bank account 122 for the corresponding transaction amount. If the response 104 indicates that a debit transaction was successful (i.e., the target bank account 142 was successfully debited 143 for the transaction amount), the source bank 120 credits 121 the source bank account 122 for the corresponding transaction amount. However, if the response 104 indicates that the transaction failed, the source bank 120 neither credits 121 nor debits 123 the source bank account 122.

For some embodiments, the source bank 120 may send a callback message 105 to the transaction processor 110 if the response 104 indicates that a particular transaction failed. For example, the source bank 120 may include a callback (CB) generator 125 which generates the callback message 105 upon determining that the TR request 101 could not be processed. Furthermore, the callback message 105 may indicate one or more reasons why the corresponding transaction failed (e.g., the target bank account 142 does not exist, the target bank account 142 has insufficient funds, a stop payment request was issued for the target bank account 142, and/or the target bank account 142 is closed or no longer active). For some embodiments, the CB generator 125 may output the callback message 105 only if the response 104 indicates a failed transaction. For other embodiments, the CB generator 125 may output the callback message 105 upon receiving the response 104, regardless of whether the transaction succeeded or failed. For example, the callback message 105 may affirmatively specify whether or not the TR request 101 was successfully processed (e.g., including the reasons for failure, if applicable).

For some embodiments the transaction processor 110 determines whether to update the user account 112 based on the callback message 105. For example, the transaction processor 110 may include a CB processor 115 that “listens” for (e.g., monitors or detects) callback messages 105 from the CB generator 125. For some embodiments, the CB processor 115 may disable or prevent the transaction processor 110 from updating the user account 112 until it receives an affirmative response (e.g., in the form of a callback message 105) from the source bank 120 indicating whether or not the TR request 101 was successfully processed. Thus, the transaction processor 110 may determine whether and/or how to update the user account 112 based on the information included in the callback message 105. For example, if the callback message 105 specifies that a transaction was successful, the transaction processor 110 may credit 111 or debit 113 the user account 112 (e.g., depending on the type of transaction originally specified by the TR request 101). However, if the callback message 105 indicates that the transaction failed, the transaction processor 110 neither credits 111 nor debits 113 the user account 112.

For other embodiments, CB processor 115 may disable or prevent the transaction processor 110 from updating the user account 112 for a predetermined period of time after outputting the TR request 101. For example, the transaction processor 110 may update the user account 112 The predetermined period is long enough such that the transaction processor 110 would receive a callback message 105 (i.e., if the TR request 101 could not be processed) before the period expires. More specifically, the predetermined period may be determined based on the amount of time it takes the source bank 120 to: receive the TR request 101, output the instruction 103, receive the response 104, and generate a callback message 105 (if the transaction failed). Thus, the transaction processor 110 may determine whether and/or how to update the user account 112 based on whether or not a callback message 105 is received before the predetermined period of time expires. For example, if the CB processor 115 does not receive a callback message 105 before the period expires (i.e., indicating a successful transaction), the transaction processor 110 may credit 111 or debit 113 the user account 112 (e.g., depending on the type of transaction originally specified by the TR request 101). However, if the CB processor 115 receives a callback message 105 before the period expires, the transaction processor neither credits 111 nor debits 113 the user account 112.

It should be noted that, because the transaction processor 110 is programmatically notified (via the CB processor 115) of the success or failure of any inter-bank transfer (e.g., between the source bank 120 and the target bank 140), the transaction processor 110 (and/or the CB processor 115) may be configured to perform any number of additional actions upon learning that a particular transaction failed or succeeded. For some embodiments, the transaction processor 110 may notify the user directly (e.g., via the user terminal 150) that a requested transaction failed and/or specify the reasons for the failure. Alternatively, or in addition, the transaction processor 110 may notify an operator or administrator of a failed transaction. For other embodiments, the transaction processor 110 may store a record of each failed transaction (e.g., for fraud detection purposes).

Performing callbacks to the transaction processor 110 allows the transaction processor 110 to programmatically account for and/or respond to any failed transactions. Furthermore, callback messages provide a reliable means of indicating (to the transaction processor) whether or not a transaction between the source bank 120 and the target bank 140 was successful. This may significantly reduce and/or eliminate accounting errors by the transaction processor, while also reducing overhead costs (e.g., human resources).

Methodology

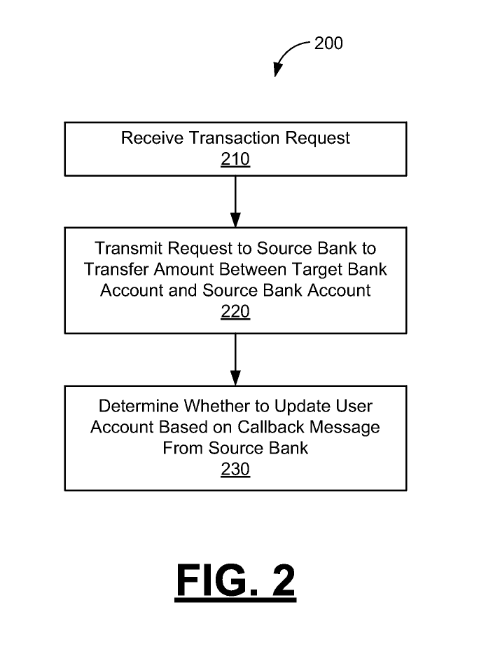

FIGS. 2-4 are illustrative flow charts depicting commercial transaction processing operations, in accordance with some embodiments. Methods such as described by examples of FIGS. 2-4 may be implemented using, for example, a system such as described with respect to FIG. 1. Accordingly, reference may be made to elements of FIG. 1 for purposes of illustrating suitable components for performing a step or sub-step being described.

With respect to the commercial transaction processing operation 200 depicted in FIG. 2, the transaction processor 110 first receives a transaction (TN) request from a user (210). As described above with respect to FIG. 1, the TN request 151 specifies an amount to be transferred between an account associated with the user (e.g., user account 112) and a third-party bank account (e.g., target bank account 142). For example, the TN request 151 may include information identifying the target bank account 142 (e.g., an account number) as well as the target bank 140 (e.g., a routing number).

The transaction processor 110 then transmits a transfer (TR) request to a source bank to transfer the amount between the target bank account and a source bank account associated with the source bank 120 (220). For some embodiments, the TR request 101 may include information identifying the source bank account (e.g., source bank account 122). For example, the TR request 101 may specify an amount to be debited from the target bank account 142 and credited to the source bank account 122. Alternatively, the TR request 101 may specify an amount to be credited to the target bank account 142 and debited from the source bank account 122.

Finally, the transaction processor 110 determines whether to update a user account associated with the user based on a callback message from the source bank (230). For example, the source bank 120 may generate and/or output the callback message 105 only if the requested transaction failed (e.g., as indicated by the target bank 140). Alternatively, the source bank 120 may generate and/or output the callback message 105 regardless of whether the requested transaction failed or succeeded (i.e., the callback message 105 affirmatively specifies whether or not a particular transaction was successful). Thus, for some embodiments, the transaction processor 110 may determine whether and/or how to update the user account 112 based on the information included in the callback message 105. For other embodiments, the transaction processor 110 may determine whether and/or how to update the user account 112 based on whether or not a callback message 105 is received before the predetermined period of time expires.

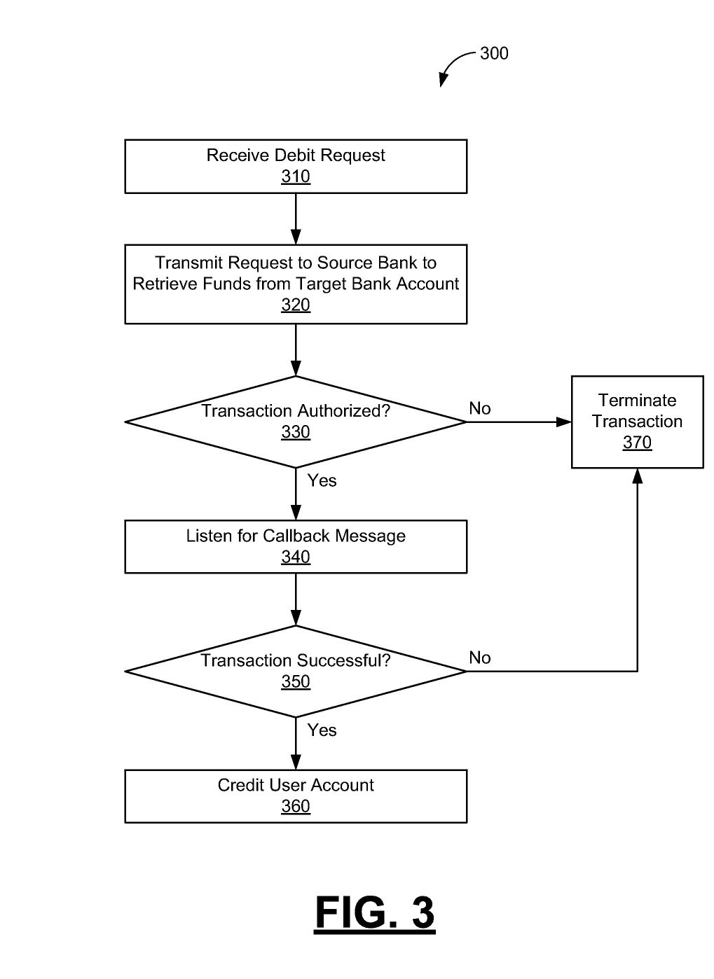

FIG. 3 is an illustrative flow chart depicting a callback operation 300 for processing debit requests, in accordance with some embodiments. With reference, for example, to FIG. 1, the transaction processor 110 receives a debit request from a user (310). The debit request may specify an amount to be debited from a third-party bank account (e.g., target bank account 142) and thus credited to the user's account (e.g., user account 112). Furthermore, the debit request may include information identifying the target bank account 142 as well as the target bank 140.

The transaction processor 110 transmits a retrieval request to a source bank to retrieve the funds (i.e., the debit amount) from the target bank account and deposit the funds in a source bank account associated with the source bank (320). For some embodiments, the retrieval request may include information identifying the source bank account (e.g., source bank account 122). For example, the retrieval request may specify an amount to be debited from the target bank account 142 and credited to the source bank account 122.

The transaction processor 110 then determines whether the transaction is authorized (330). For example, the source bank 120 may analyze the retrieval request to determine whether the routing number is associated with a valid bank. The source bank 120 may then send a response 102 to the transaction processor 110 indicating whether the transaction is authorized (e.g., depending on whether the routing number is valid). If the transaction is not authorized (330), the transaction processor 110 simply terminates the transaction (370). For some embodiments, the transaction processor 110 may notify the user (e.g., via the user terminal 150) that the transaction could not be completed because the routing number is invalid.

If the transaction is authorized (330), the transaction processor 110 proceeds to listen for a callback message from the source bank (340). As described above, with respect to FIG. 1, the CB generator 125 generates the callback message 105 based on the response 104 from the target bank 140. For some embodiments, the CB generator 125 may generate and/or output the callback message 105 only if the response 104 indicates that requested amount could not be debited from the target bank account 142. For other embodiments, the CB generator 125 may generate and/or output the callback message 105 upon receiving the response 104, such that the callback message 105 affirmatively specifies whether or not the amount was debited from the target bank account 142. The transaction processor 110 may include a CB processor 115 that listens for (e.g., monitors or detects) callback messages 105 from the CB generator 125.

The transaction processor 110 determines whether the transaction was successful (350). For some embodiments, the transaction processor 110 may determine whether to update the user account 112 based on the information included in the callback message 105. For other embodiments, the transaction processor 110 may determine whether to update the user account 112 based on whether or not a callback message 105 is received before the predetermined period of time expires. If the transaction was successful (350), the transaction processor 110 credits the user account for the requested amount (360).

If the transaction was not successful (350), the transaction processor 110 may terminate the transaction (370). For some embodiments, the transaction processor 110 may notify the user that the transaction could not be completed and/or indicate the reasons why. Such reasons may be provided in the callback message 105 received from the source bank 120, and include, for example: the target bank account 142 does not exist; the target bank account 142 has insufficient funds; a stop payment request was issued for the target bank account 142; and/or the target bank account 142 is closed or no longer active.

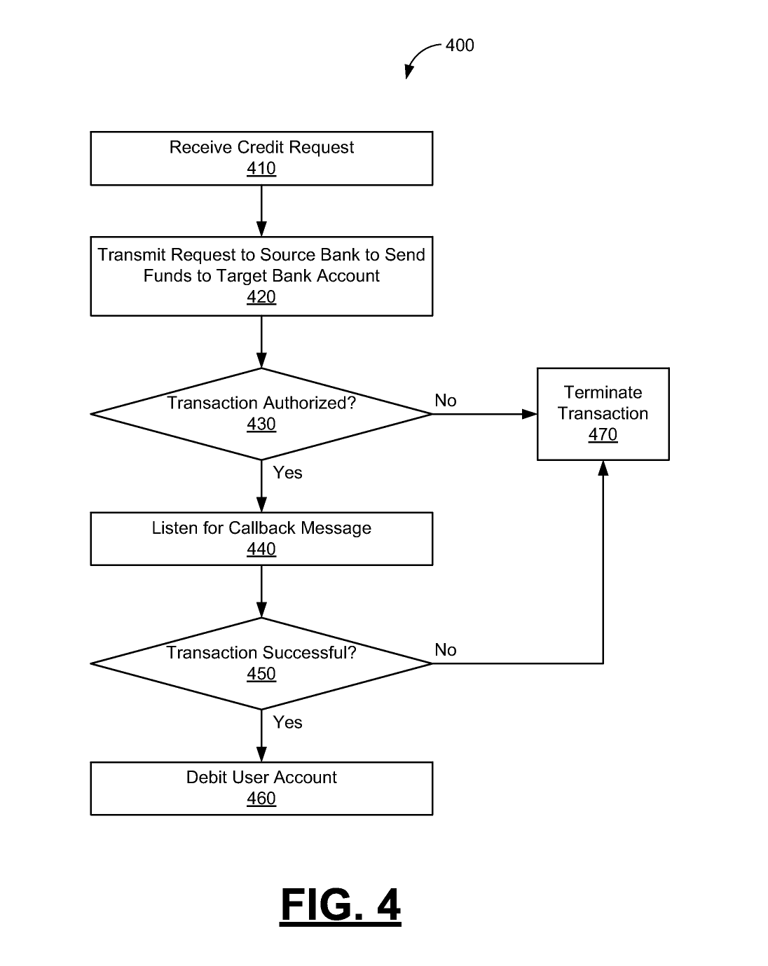

FIG. 4 is an illustrative flow chart depicting a callback operation 400 for processing credit requests, in accordance with some embodiments. With reference, for example, to FIG. 1, the transaction processor 110 receives a credit request from a user (410). The credit request may specify an amount to be credited to a third-party bank account (e.g., target bank account 142) and thus debited from the user's account (e.g., user account 112). Furthermore, the credit request may include information identifying the target bank account 142 as well as the target bank 140.

The transaction processor 110 transmits a deposit request to a source bank to transfer the funds (i.e., the credit amount) from a source bank account associated with the source bank to the target bank account (420). For some embodiments, the deposit request may include information identifying the source bank account (e.g., source bank account 122). For example, the deposit request may specify an amount to be credited to the target bank account 142 and debited from the source bank account 122.

The transaction processor 110 then determines whether the transaction is authorized (430). For example, the source bank 120 may analyze the deposit request to determine whether the routing number is associated with a valid bank. The source bank 120 may then send a response 102 to the transaction processor 110 indicating whether the transaction is authorized (e.g., depending on whether the routing number is valid). If the transaction is not authorized (430), the transaction processor 110 simply terminates the transaction (470). For some embodiments, the transaction processor 110 may notify the user (e.g., via the user terminal 150) that the transaction could not be completed because the routing number is invalid.

If the transaction is authorized (430), the transaction processor 110 proceeds to listen for a callback message from the source bank (440). As described above, with respect to FIG. 1, the CB generator 125 generates the callback message 105 based on the response 104 from the target bank 140. For some embodiments, the CB generator 125 may generate and/or output the callback message 105 only if the response 104 indicates that requested amount could not be credited to the target bank account 142. For other embodiments, the CB generator 125 may generate and/or output the callback message 105 upon receiving the response 104, such that the callback message 105 affirmatively specifies whether or not the amount was credited to the target bank account 142. The transaction processor 110 may include a CB processor 115 that listens for (e.g., monitors or detects) callback messages 105 from the CB generator 125.

The transaction processor 110 determines whether the transaction was successful (450). For some embodiments, the transaction processor 110 may determine whether to update the user account 112 based on the information included in the callback message 105. For other embodiments, the transaction processor 110 may determine whether to update the user account 112 based on whether or not a callback message 105 is received before the predetermined period of time expires. If the transaction was successful (450), the transaction processor 110 credits the user account for the requested amount (460).

If the transaction was not successful (450), the transaction processor 110 may terminate the transaction (470). For some embodiments, the transaction processor 110 may notify the user that the transaction could not be completed and/or indicate the reasons why. Such reasons may be provided in the callback message 105 received from the source bank 120, and include, for example: the target bank account 142 does not exist and/or the target bank account 142 is closed or no longer active.

It should be noted, however, that the transaction processor 110 may not be subjected to the same risk (of fraud) when processing credit requests as is the case when processing debit requests, because the transaction processor 110 debits the user account 112 in order to credit the target bank account 142. Thus, for some embodiments, the transaction processor 110 may debit the user account 112 as soon as the transaction is authorized (430), and if the transaction is ultimately unsuccessful (450) the transaction processor 110 may credit the amount back to the user account 112.

Computer System

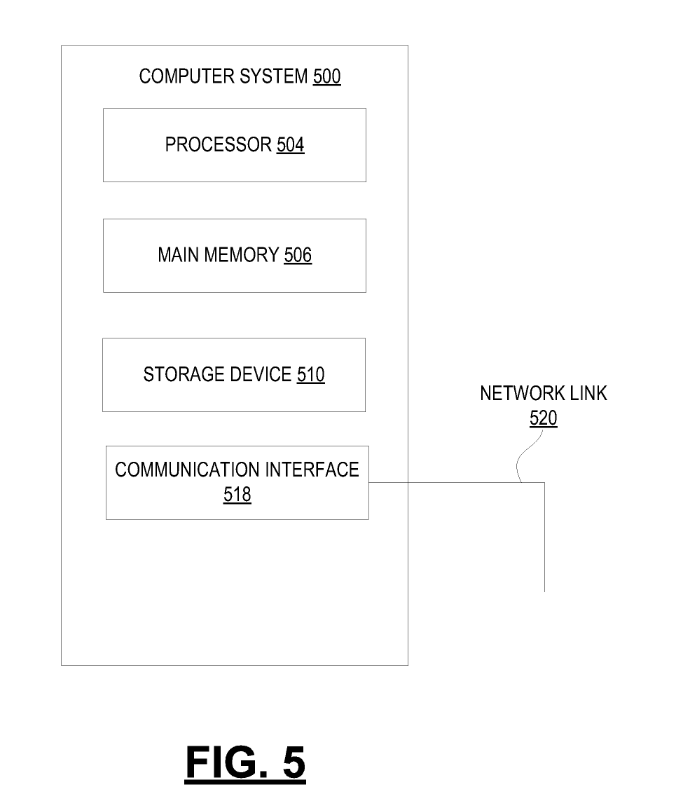

FIG. 5 is a block diagram that illustrates a computer system upon which embodiments described herein may be implemented. For example, in the context of FIG. 1, system 100 may be implemented using one or more servers such as described by FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 (wireless or wired line). The communication interface 518 may communicate with users using, for example, the Internet.

Embodiments described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A system for processing commercial transactions, the system comprising:
a transaction processor to receive a transaction request from a user, wherein the transaction request includes an amount to be transferred between a user account and a first bank account associated with a first bank; and
a second bank coupled to the transaction processor, wherein the second bank is to:
transmit an instruction to the first bank to transfer the amount between the first bank account and a second bank account associated with the second bank;
receive a response from the first bank indicating whether the amount can be transferred; and
selectively generate a callback message based on the response from the first bank;
wherein the transaction processor determines whether to update the user account to reflect the amount to be transferred based, at least in part, on the callback message.

2. The system of claim 1, wherein the callback message indicates whether the amount was successfully debited from or credited to the first bank account.

3. The system of claim 2, wherein the amount to be transferred includes an amount to be debited from the first bank account, and wherein the transaction processor credits the amount to the user account if the callback message indicates that the amount was successfully debited from the first bank account.

4. The system of claim 3, wherein the second bank further receives the amount from the first bank and deposits the amount in the second bank account.

5. The system of claim 2, wherein the amount to be transferred includes an amount to be credited to the first bank account, and wherein the transaction processor debits the amount from the user account if the callback message indicates that the amount was successfully credited to the first bank account.

6. The system of claim 2, wherein the second bank generates the callback message regardless of whether the amount was successfully debited from or credited to the first bank account.

7. The system of claim 1, wherein the callback message indicates that the transaction request could not be completed, and wherein the second bank generates the callback message only if the response from the first bank indicates that the amount was not debited from or credited to the first bank account.

8. The system of claim 7, wherein the transaction processor updates the user account if no callback message is received after a predetermined amount of time has elapsed.

9. The system of claim 1, wherein the callback message indicates that the transaction request could not be completed because of at least one of: (i) the first bank account does not exist, (ii) the first bank account has insufficient funds, (iii) a stop payment request was issued for the first bank account, or (iv) the first bank account is closed or no longer active.

10. The system of claim 1, wherein the second bank communicates with the first bank via an Automated Clearing House (ACH) network.

11. A method of conducting commercial transaction, the method being implemented by one or more processors and comprising:
receiving a transaction request from a user, wherein the transaction request includes an amount to be transferred between a user account and a first bank account associated with a first bank; and
transmitting a transfer request to a second bank to negotiate a transfer of the amount between the first bank account and a second bank account associated with the second bank;
determining whether to update the user account to reflect the amount to be transferred based, at least in part, on a callback message from the second bank.

12. The method of claim 11, wherein the callback message indicates whether the amount was successfully debited from or credited to the first bank account.

13. The method of claim 12, wherein the amount to be transferred includes an amount to be debited from the first bank account, and wherein determining whether to update the user account comprises:
crediting the amount to the user account if the callback message indicates that the amount was successfully debited from the first bank account.

14. The method of claim 12, wherein the amount to be transferred includes an amount to be credited to the first bank account, and wherein determining whether to update the user account comprises:
debiting the amount from the user account if the callback message indicates that the amount was successfully credited to the first bank account.

15. The method of claim 12, wherein determining whether to update the user account comprises:
receiving the callback message from the second bank; and
updating the user account to reflect the amount to be transferred if the callback message indicates that the amount was successfully debited from or credited to the first bank account.

16. The method of claim 11, wherein the callback message indicates that the transaction request could not be completed, and wherein determining whether to update the user account comprises:
updating the user account to reflect the amount to be transferred if no callback message is received after a predetermined amount of time has elapsed.

17. The method of claim 11, wherein the callback message indicates that the transaction request could not be completed because of at least one of: (i) the first bank account does not exist, (ii) the first bank account has insufficient funds, (iii) a stop payment request was issued for the first bank account, or (iv) the first bank account is closed or no longer active.

18. The method of claim 1, wherein the second bank negotiates with the first bank via an ACH network.

19. A computer-readable medium that stores instructions that, when executed by one or more processors, cause the one or more processors to perform operations comprising:
receiving a transaction request from a user, wherein the transaction request includes an amount to be transferred between a user account and a first bank account associated with a first bank; and
transmitting a request to a second bank to negotiate a transfer of the amount between the first bank account and a second bank account associated with the second bank;
determining whether to update the user account to reflect the amount to be transferred based, at least in part, on a callback message from the second bank.

20. The computer-readable medium of claim 19, wherein the second bank negotiates with the first bank via an ACH network.
